(19) United States
(12) Patent Application Publication
(10) Pub. No.: US 2020/0106987 A1
(43) Pub. Date: Apr. 2, 2020

(54) MULTI-HEAD VIDEO PRESENTATION CABLE

(71) Applicant: Crestron Electronics, Inc., Rockleigh, NJ (US)

(72) Inventor: Joseph Sarrasin, Rockleigh, NJ (US)

(73) Assignee: Crestron Electronics, Inc., Rockleigh, NJ (US)

(21) Appl. No.: 16/148,199

(22) Filed: Oct. 1, 2018

(51) Int. Cl. H04N 7/10; H04N 7/01

(52) U.S. Cl. CPC H04N 7/104; H04N 7/0125; H04N 7/0117

(57) ABSTRACT

A video conversion cable, comprising: a plurality of receptacles adapted to receive video signals from respective video sources via a respective one of a plurality of video cables, each of the respective video signals having a respective video protocol; an auto sensing switch (switch) adapted to automatically select a first video signal that appears at one of the plurality of inputs to the switch and output the same; a video converter adapted to receive the selected and outputted first video signal, and convert the same from its respective video protocol to a high definition multi-media interface (HDMI) video protocol, unless the received signal was already an HDMI video protocol signal, and wherein the video converter is further adapted to output the HDMI video signal via an output HDMI cable to an HDMI video sink to display the HDMI video signal; and a pig-tail connector adapted to receive power to be sent to the switch and video converter via the output HDMI cable.

### BACKGROUND OF THE INVENTION

### Technical Field

The embodiments described herein relate generally to video cables, and more specifically to systems, methods, and modes for a video cable that can convert a video signal from several different types of digital video signal protocols to a high definition multi-media interface (HDMI) protocol video signal.

### Background Art

In many corporate or school settings, people are often called on to give a presentation. Typically, however, a presenter using a conference room or classroom needs a variety of cables and/or connectors to connect presenter devices to the room display or projector. The presenter can carry a variety of adapters that work between his/her devices and the variety of display and projector connections. But, as has probably happened to many people, the adapters are easily lost, misplaced, or left behind.

Likewise, the facility can carry a variety of adapters. But again, the adapters are easily lost, misplaced, or accidentally packed up and walked off with. The only real solution that ensures being able to present the information is for the facilities to purchase an expensive video switching device and a number of different kinds of cables that are all permanently installed. However, those of skill in the art can appreciate that this can be an expensive solution. Thus, there is a need for a video cable that can convert a video signal from several different types of digital video signal protocols to a high definition multi-media interface (HDMI) protocol video signal.

### SUMMARY

It is an object of the embodiments to substantially solve at least the problems and/or disadvantages discussed above, and to provide at least one or more of the advantages described below.

It is therefore a general aspect of the embodiments to provide systems, methods, and modes for a video cable that can convert a video signal from several different types of digital video signal to a high definition multi-media video interface (HDMI) signal that will obviate or minimize problems of the type previously described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

According to a first aspect of the embodiments, a video conversion cable is provided comprising a video conversion cable, comprising: a plurality of receptacles adapted to receive video signals from respective video sources via a respective one of a plurality of video cables, each of the respective video signals having a respective video protocol; an auto sensing switch (switch) adapted to automatically select a first video signal that appears at one of the plurality of inputs to the switch and output the same; a video converter adapted to receive the selected and outputted first video signal, and convert the same from its respective video protocol to a high definition multi-media interface (HDMI) video protocol, unless the received signal was already an HDMI video protocol signal, and wherein the video converter is further adapted to output the HDMI video signal via an output HDMI cable to an HDMI video sink to display the HDMI video signal; and a pig-tail connector adapted to receive power to be sent to the switch and video converter via the output HDMI cable.

According to the first aspect of the embodiments, the video conversion cable further comprises a circuit board upon which are located the switch, and the video converter.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

FIG. 1 illustrates a block diagram of a multi-head video presentation cable according to aspects of the embodiments.

FIG. 2 illustrates a general view of the multi-head video presentation cable as shown in FIG. 1 in a form factor as can be manufactured according to aspects of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices, such as video cables, and more specifically, multi-head video presentation cables.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE ELEMENTS IN THE DRAWINGS IN NUMERICAL ORDER

The following is a list of the major elements in the drawings in numerical order.
100 Multi-head Video Presentation Cable (MHVPC)
102 Switch/Converter Board
104 Video Input Connector
106 3:1 Auto-sense Switch
108 HDMI Video Converter
110 HDMI Protocol Video Cable (HDMI Cable)
114 HDMI Video Cable Connector
116 HDMI Video Cable Receptacle
118 HDMI Video Display Device (Video Sink)
120 Video Display Source Cable (Source Cable)
122 Pig-tail Power Connector
124 Pig-tail Power Connector Receptacle (Power Receptacle)

### LIST OF ACRONYMS USED IN THE SPECIFICATION IN ALPHABETICAL ORDER

The following is a list of the acronyms used in the specification in alphabetical order.
ASIC Application Specific Integrated Circuit
MHVPC Multi-Head Video Presentation Cable
HDMI High Definition Multi-media Interface
MDP Mini-Display Port
RGBHV Red-Green-Blue-Horizontal-Vertical
USB Universal Serial Bus
VGA Video Graphics Array

The different aspects of the embodiments described herein pertain to the context of a video cable that can convert a video signal from several different types of digital video signal to an HDMI video signal, but is not limited thereto, except as may be set forth expressly in the appended claims.

For 40 years Creston Electronics Inc., has been the world's leading manufacturer of advanced control and automation systems, innovating technology to simplify and enhance modern lifestyles and businesses. Crestron designs, manufactures, and offers for sale, integrated solutions to control audio, video, computer, and environmental systems. In addition, the devices and systems offered by Crestron streamlines technology, improving the quality of life in commercial buildings, universities, hotels, hospitals, and homes, among other locations. Accordingly, the systems, methods, and modes of the aspects of the embodiments described herein, as embodied as a Dante In-Ceiling Commercial Loudspeaker, can be manufactured by Crestron Electronics Inc., located in Rockleigh, N.J.

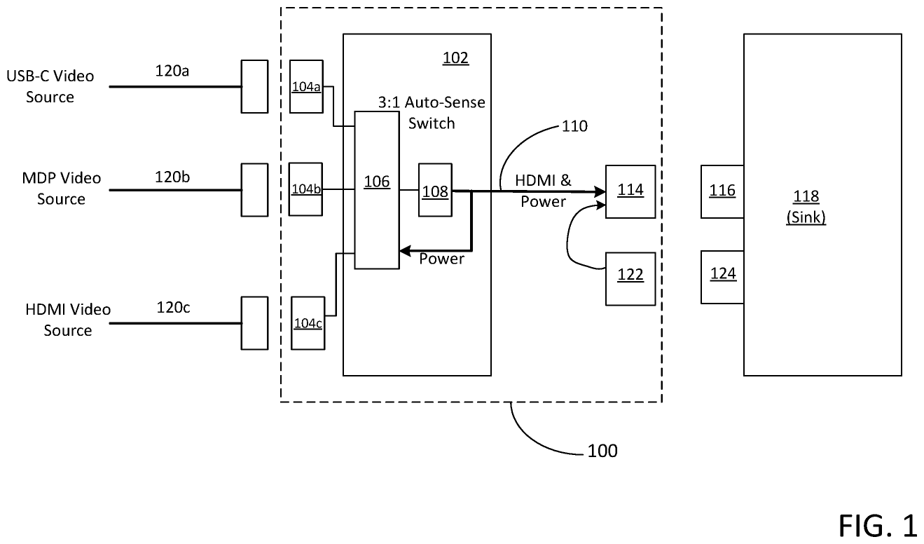

FIG. 1 illustrates a block diagram of multi-head video presentation cable MHVPC 100 according to aspects of the embodiments. Input to MHVPC 100 are up to three different types (protocols) of video signal, through cables 120a-c, which are connected to video input connectors (input connectors) 104a-c, respectively. Any one of the three types of cables 120a-c can be connected, or any combination thereof, up to all three. The three types of cables 120a-c (protocols) include: (1) on 120a, Universal Serial Bus—Type C (USB-C) (with a male connector; all of the connectors on cables 120a-d that connect to MHVPC 100 can be male, though this need not always be the case); (2) on 120b, mini-display port (Mini DisplayPort (MiniDP or mDP) is a miniaturized version of the DisplayPort audio-visual digital interface, and was created by Apple, Inc.), and (3) on 120c, HDMI.

According to further aspects of the embodiments, additional video protocols that can be used, in addition to, or in place or, those discussed above, include standard display port display signal. Standard DisplayPort (SDP) display signals are a digital display interface developed by a consortium of personal computer and chip (integrated circuits) manufacturers and standardized by the Video Electronics Standards Association (VESA). SDP signals generally originate from a video source and are connected to a display device such as a computer monitor, and it can also carry audio, and other forms of data). Another display protocol is the video graphics array (VGA) display protocol. VGA signals are analog signals, and comprise analog component red, green, blue, horizontal sync, and vertical sync (RGBHV) video signals. In the case that an HDMI cable is connected to MHVPC 100, then, in that case, MHVPC 100 acts as a simple “pass-through” device. While several example types of video signals are discussed herein, in regard to MHVPC 100, these are merely examples only, and not to be taken in limiting sense, meaning other types of video transmission protocols can be accommodated in MHVPC 100 according to aspects of the embodiments.

In operation, if multiple video/audio sources are connected to MHVPC 100, typically only one source will be active at any given time. It is typically the case, however, that a presenter generally only has one type of video/audio source operating at any given time, and so when MHVPC 100 and auto-sense switch 106 detects activity at one of its inputs, HDMI converter 108 senses the type of video input, and then retrieves the correct software algorithm automatically to convert the received signal to HDMI. Auto-sense switch 106, located in combined switch and converter device 102 senses the “live” input, and connects it to the single output that is sent to converter 108, wherein conversion to HDMI occurs. As discussed above, however, it is sometimes the case wherein an HDMI signal is input, so that MHVPC 100 acts as a through put device.

According to further aspects of the embodiments, a user selection switch can be implemented in which the user can select which input should be used as the active input to perform conversion on and output as an HDMI signal. This switch is not shown in FIG. 1.

Once the auto-selected, or manually selected, input signal is sent to HDMI converter 108, the received, input signal is converted from its original format to an HDMI format (unless it was HDMI to begin with), and output as an HDMI video signal that is carried via HDMI cable 110 to video sink 118.

HDMI video cable connector 114 is then connected to HDMI video cable receptacle 116, which is located on HDMI video display device (video sink) 118. The now-converted HDMI video/audio signal can now be displayed on video sink 118, according to aspects of the embodiments.

Also shown as part of MHVCP 100 is pig-tail power connector 122, which is connected to connector 114. Power connector 122 is connected to pig-tail power connector receptacle (power receptacle) 124 that can be located at video sink 118. Alternatively, power connector 122 can be connected to power receptacle 124 that is part of a USB charging device (not shown).

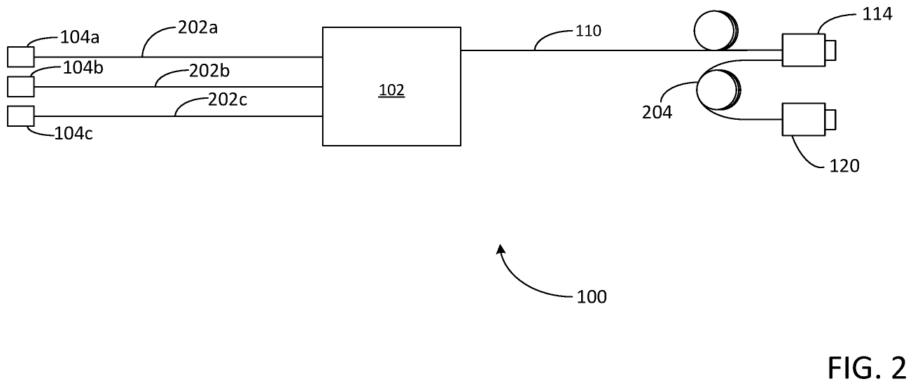

According to aspects of the embodiments, each of switch 106 and converter 108 receive their power from pig-tail power connector 122 which is sent through HDMI cable 122 back to devices 108, 106, as shown in FIG. 1. Thus, according to aspects of the embodiments, an external power source is not needed to operate MHVPC 100. Switch 106 and converter 108 can be any one of numerous form factors, such as an application specific integrated circuit (ASIC), or discrete components located on a switch/converter board 102, according to further aspects of the embodiments. FIG. 2 illustrates a general view of a MHVCP 100 according to aspects of the embodiments in a form factor as can be manufactured.

The disclosed embodiments provide a multi-head video presentation cable. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

### INDUSTRIAL APPLICABILITY

To solve the aforementioned problems, the aspects of the embodiments are directed towards a completely digitally controlled in-ceiling loudspeaker assembly.

### Alternate Embodiments

Alternate embodiments may be devised without departing from the spirit or the scope of the different aspects of the embodiments.

1. A video conversion cable, comprising:
a plurality of receptacles adapted to receive video signals from respective video sources via a respective one of a plurality of video cables, each of the respective video signals having a respective different video protocol;
an auto sensing switch (switch) adapted to automatically select a first video signal that appears at one of the plurality of inputs to the switch and output the same;
a video converter adapted to receive the selected and outputted first video signal, and convert the same from its respective video protocol to a high definition multi-media interface (HDMI) video protocol, unless the received signal was already an HDMI video protocol signal, and wherein the video converter is further adapted to output the HDMI video signal via an output HDMI cable to an HDMI video sink to display the HDMI video signal; and
a pig-tail connector adapted to receive power to be sent to the switch and video converter via the output HDMI cable.

2. The video conversion cable according to claim 2, further comprising:
a circuit board upon which are located the switch, and the video converter.
